(19) United States
(12) Patent Application Publication
(10) Pub. No.: US 2010/0069112 A1
(43) Pub. Date: Mar. 18, 2010

(54) SCHEDULING TRANSMISSIONS IN COEXISTING WIRELESS NETWORKS

(75) Inventors: Yanjun SUN, Richardson, TX (US); Ariton E. XHAFA, Plano, TX (US); Xiaolin LU, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/559,929

(22) Filed: Sep. 15, 2009

Related U.S. Application Data
(60) Provisional application No. 61/096,890, filed on Sep. 15, 2008.

(51) Int. Cl. H04M 1/00

(52) U.S. Cl. 455/553.1

(57) ABSTRACT

A system and method for scheduling channel access in a wireless device including co-located network transceivers are disclosed herein. A wireless device includes a first wireless transceiver, a second wireless transceiver, and an arbiter. The first wireless transceiver is configured for communication via a first wireless network. The second wireless transceiver is configured for communication via a second wireless network. The arbiter controls which one of the first and second transceivers is enabled to transmit at a given time. The arbiter computes a predicted a start time for a transmission via the second wireless transceiver and computes a transmission duration for a first packet pending transmission via the first transceiver. Based on the predicted start time and the computed duration, the arbiter transmits the first packet at a time when the first packet transmission does not overlap the transmission via the second wireless transceiver.

### CROSS-REFERENCE TO RELATED APPLICATIONS

This application is a non-provisional application claiming priority to provisional application Ser. No. 61/096,890, filed on Sep. 15, 2008, entitled “Smart Uplink Data Transmission In Coexisting Wireless Networks,” the teachings of which are incorporated by reference herein.

### BACKGROUND

As wireless technologies proliferate, mobile wireless devices incorporate a multiplicity of different wireless standards. For example, a cellular telephone can accommodate a cellular network (e.g., Universal Mobile Telecommunications System (“UMTS”)), a wireless local area network (“WLAN”), such as IEEE 802.11, and a wireless personal area network (“WPAN”) (e.g., Bluetooth). Including WPAN access makes utilization of a wireless device more convenient by allowing use of wireless headsets and other short-range wireless appliances.

Some of the various wireless standards adopted for use in mobile devices employ adjacent and/or overlapping portions of the wireless spectrum. For example, both Bluetooth and IEEE 802.11b/g/n occupy the 2.45 GHz band.

### SUMMARY

A system and method for scheduling channel access in a wireless device including co-located network transceivers are disclosed herein. In one embodiment, a wireless device includes a first wireless transceiver, a second wireless transceiver, and an arbiter. The first wireless transceiver is configured for communication via a first wireless network. The second wireless transceiver is configured for communication via a second wireless network. The arbiter controls which of the first and second transceivers is enabled to transmit at a given time. The arbiter computes a predicted a start time for a transmission via the second wireless transceiver and computes a transmission duration for a first packet pending transmission via the first transceiver. Based on the predicted start time and the computed duration, the arbiter transmits the first packet at a time when the first packet transmission does not overlap the transmission via the second wireless transceiver.

In another embodiment, a wireless device includes a first wireless transceiver, a second wireless transceiver, and an arbiter. The first wireless transceiver is configured for communication via a first wireless network. The second wireless transceiver is configured for communication via a second wireless network. The arbiter controls which of the first and second transceivers is enabled to transmit at a given time. The arbiter, during a first transmission of a packet via the first transceiver, disables the first transceiver and enables transmission by the second transceiver. The arbiter reschedules retransmission of the packet, the rescheduling based on a time after the first transmission of the packet would have completed had the first transceiver not been disabled.

In a further embodiment, a method includes determining a start time for a predictable data transmission via a second wireless transceiver in a wireless device. A request to transmit a first packet via a first wireless transceiver in the wireless device is received. Whether transmission of the first packet will overlap the predicable data transmission if the first packet transmission is started prior to the predictable data transmission is determined. Transmission of the first packet is scheduled for a time after the predictable data transmission is complete based on determining that the transmission of the first packet will overlap the predictable data transmission

### BRIEF DESCRIPTION OF THE DRAWINGS

For a detailed description of exemplary embodiments of the invention, reference will now be made to the accompanying drawings in which:

FIG. 1 shows a wireless system including wireless devices that use two interfering wireless networks in accordance with various embodiments;

FIG. 2 shows a diagram of signals transmitted by a wireless device including scheduling to avoid conflicts with predictable transmissions in accordance with various embodiments;

FIG. 3 shows a diagram of signals transmitted by a wireless device including rescheduling of an interrupted transmission to avoid a conflict with the interrupted transmission in accordance with various embodiments;

FIG. 4 shows a block diagram of a wireless device including network arbitration and transmission scheduling to improve channel utilization in accordance with various embodiments; and

FIG. 5 shows a flow diagram for a method for improving channel utilization by scheduling network transmissions to avoid interruptions and self-interruptions in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein are a system and method for scheduling access to a wireless transmission channel in a system that includes wireless devices using multiple conflicting wireless networks. Mobile wireless devices are sometimes capable of accessing multiple exclusive wireless networks. Such wireless networks can occupy adjacent or overlapping frequency spectrum. For example, Bluetooth and IEEE 802.11b/g/n both utilize the 2.45 GHz band. Access to the networks can be coordinated via time multiplexing to reduce performance degradation caused by collisions that may occur when the networks are simultaneously accessed. In a wireless device configured for operation with co-existing networks, transmission on one network may be given priority over transmissions on another network. For example, transmission of audio data on a first network may require low latency and therefore may be given priority over best effort traffic on another network. Consequently, best effort data transmissions on the second network may be interrupted to allow higher priority transmissions on the first network. Devices receiving the interrupted transmission may have reserved the channel for the interrupted transmission for the expected duration of the transmission. Consequently, the channel will be wasted for the duration of the interrupted transmission. Furthermore, if the device whose transmission was interrupted begins retransmission of the interrupted data before the interrupted transmission would have completed, a portion of the retransmission may be deemed part of the original (i.e., the interrupted) transmission by a receiving device thereby resulting in corruption of the retransmission.

Embodiments of the present disclosure schedule data transmissions on a first network in light of predicted data transmissions on a second network and/or interrupted transmissions on the first network. By considering these factors in network transmission scheduling, embodiments minimize failed data transmissions and improve overall network performance.

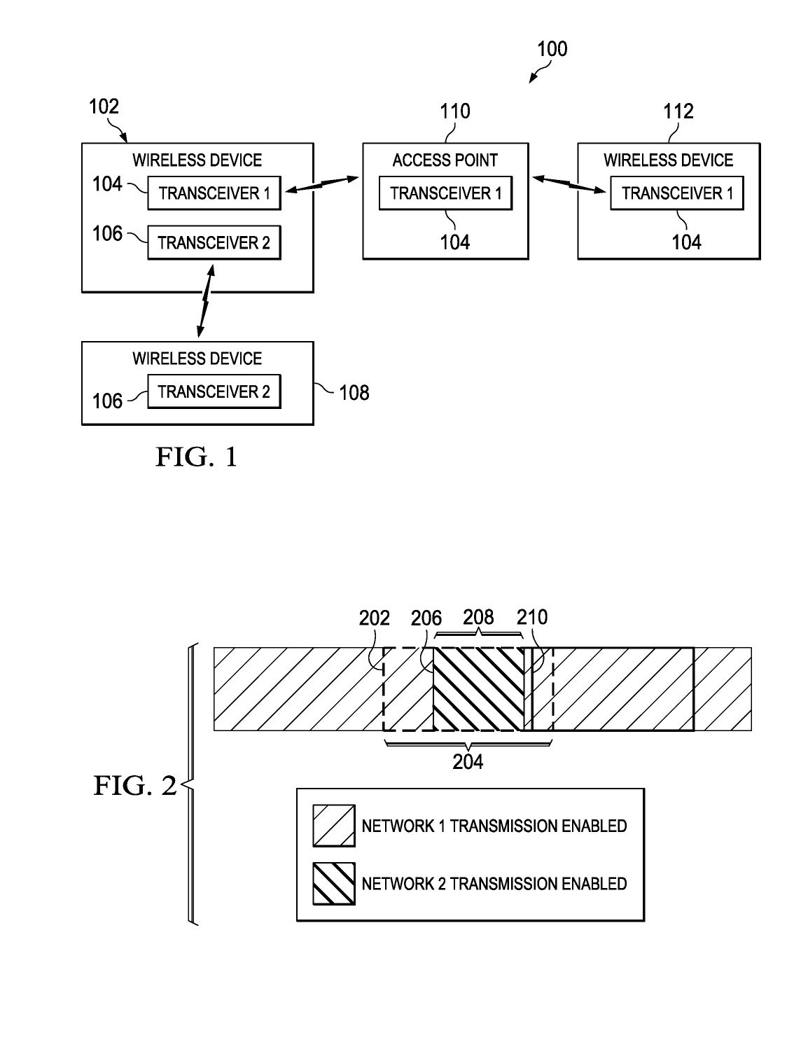

FIG. 1 shows an embodiment of a wireless system including wireless devices configured to use two different wireless networks that may interfere with one another when simultaneously accessed. The wireless system 100 includes an access point 110, and wireless devices 102, 108, and 112. The access point 110, and the wireless devices 102, 112 each include a wireless transceiver 104. The wireless transceiver 104 allows the access point 110 and the wireless devices 102, 112 to communicate via a first wireless network, for example, a wireless local area network (“WLAN”) (e.g., IEEE 802.11 b/g/n).

The wireless device 108 includes a wireless transceiver 106. The wireless transceiver 106 allows the wireless device 108 to communicate via a second wireless network, for example, a wireless personal area network (“WPAN”) (e.g., Bluetooth). The wireless device 102 also includes a second wireless transceiver 106 allowing communication via the second network with the wireless device 108.

While the system 100 is shown with a limited number of wireless devices, in practice, the system 100 may include any number of wireless devices. Exemplary mobile wireless devices 102, 112 include cellular telephones, personal digital assistants, personal computers, navigation devices, personal music players, video gaming systems, etc. Exemplary mobile wireless device 106 may be a wireless headset, wireless earphones, etc.

The access point 110 can also be referred to as a base station, a node B, etc. The access point 110 may connect the wireless devices 102, 112 to a wired network, serve as an intermediary for communication between the wireless devices 102, 112, and/or provide other networking services (e.g., timing services) to the wireless devices 102, 112. Some embodiments of the system 100 can employ ad-hoc networking, and may not include the access point 102. Instead, in such embodiments, the mobile wireless devices 102, 112 can communicate directly with one another.

The first wireless network is incompatible with the second wireless network in that the wireless technologies and/or protocols used by the second network do not allow for wireless communications via the first network. The frequency bands used by the second network can be adjacent to or overlap the frequency bands used by the first network. Consequently, operation of the first network can interfere with operation of the second network by directly interfering with transmissions in overlapping bands or by out-of-band emissions that saturate receivers or interfere with transmissions in adjacent frequency bands. The wireless device 102 time multiplexes access to the communication channel to reduce interference between the co-existing networks. If transactions on one network (e.g., the second network) are considered more time critical than transactions on the other network, then second network transactions may preempt in progress transactions on the first network resulting in inefficient utilization of the first network.

The wireless device 102 schedules transmissions via transceiver 1 104 to avoid conflicts with predictable transmissions via transceiver 2 106. For example, if voice or other audio data are being transmitted via the second network, the transmissions may be scheduled to occur at a regular interval and thus at a predictable time. The wireless device 102 can avoid scheduling transmissions via transceiver 1 104 that will overlap the predictable network 2 transmissions.

Further, if a packet transmission in progress via the transceiver 1 104 is interrupted by a higher priority transmission via transceiver 2 106, the wireless device 102 reschedules the interrupted packet for retransmission at a time that reduces the possibility of retransmission corruption. More specifically, the wireless device 102 retransmits the interrupted packet at a time after the packet transmission would have completed if not interrupted. Such scheduling reduces the likelihood that a wireless device receiving the retransmitted packet (e.g., the access point 110) interprets the retransmission as a continuation of the original (i.e., the interrupted) transmission.

FIG. 2 shows a diagram of signals transmitted by a wireless device including scheduling to avoid conflicts with predictable transmissions in accordance with various embodiments. In FIG. 2, the wireless device 102 is ready to transmit. At point 202 a packet is available for transmission on the first network via the transceiver 1 104. The transmit duration 204 of the packet is also shown. At point 202, when the packet becomes available for transmission, the wireless device 102 determines whether a predictable transmission via the transceiver 2 106 would interrupt the transmission of the packet if the packet is transmitted prior to the predictable transmission. If a predictable transmission via transceiver 2 106 will interrupt transmission of the packet via transceiver 1 104, then any channel access time reserved for transmission of the packet (i.e., duration 204) will be wasted. Here, the wireless device 102 determines at point 202 that a predictable transmission via transceiver 2, 106 having duration 208 may commence at point 206. If transmission of the available packet starts before the predictable transmission, the packet will be interrupted. Consequently, the wireless device 102 schedules transmission of the packet on the first network to begin at time 210 after the completion of the predictable transmission on the second network. The wireless device 102 may use the time prior to point 206 to transmit a different packet on the first network (i.e., a packet that can be completely transmitted prior to point 206). Other wireless devices using the first network (e.g., device 112 or access point 110) may also be free to transmit between points 202 and 206, and/or during duration 208 because the channel is not reserved for transmission by wireless device 102.

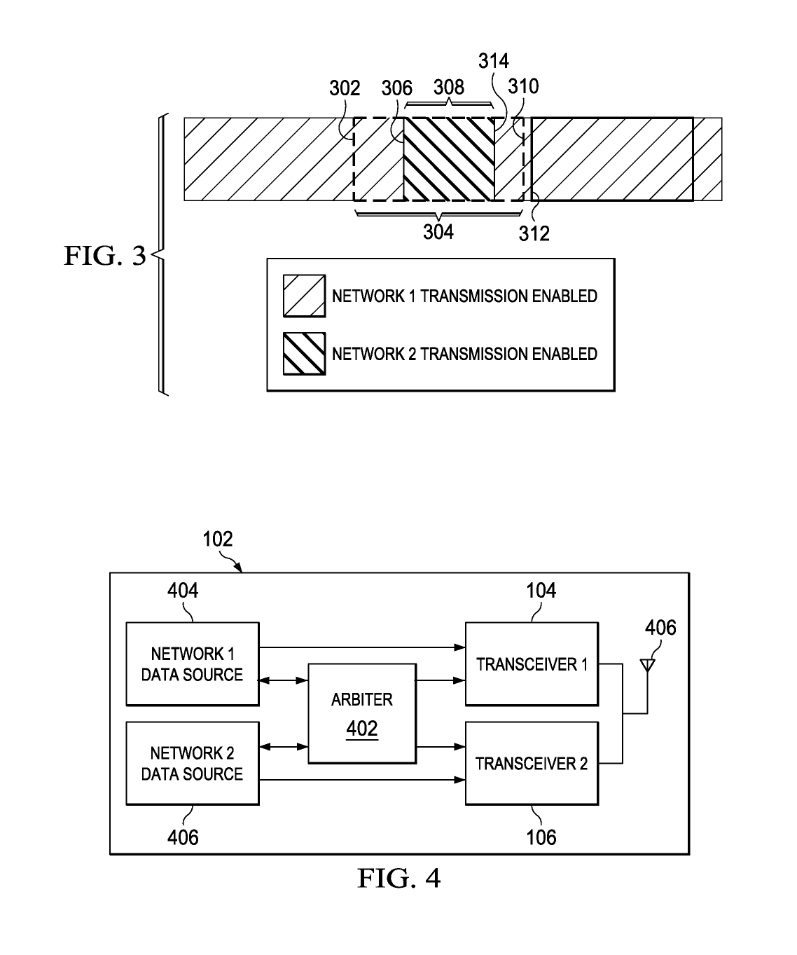

FIG. 3 shows a diagram of signals transmitted by a wireless device including rescheduling of an interrupted transmission to avoid a conflict with the interrupted transmission in accordance with various embodiments. In FIG. 3, the wireless device 102 is ready to transmit and at point 302 transmission of a packet on the first network commences via transceiver 1 104. The transmit duration 304 of the packet is also shown. During the transmission of the packet, an unpredictable request to transmit on the second network via transceiver 2 106 for duration 308 is received at point 306. Because the data to be transmitted via transceiver 2 106 has priority over the packet being transmitted via transceiver 1 104, the ongoing packet transmission is discontinued. The wireless device 102 may then reschedule the packet for transmission at a time after the higher priority second network transmission is complete (point 314). If the wireless device schedules the retransmission for a time between the end of the higher priority transmission 314 and the time when the discontinued packet transmission would have ended 310, wireless devices receiving the retransmission may deem a portion of the retransmission to be part of the original (i.e., the discontinued) transmission. If this misinterpretation occurs, the retransmitted packet will be corrupted (the first portion of the packet is lost), and the wireless device 102 will retransmit the packet yet again.

The aforementioned misinterpretation of the retransmitted packet stems from information transmitted in the header of the interrupted packet that defines the duration of the packet transmission. Wireless devices receive the duration information and presume all data transmitted during the duration are part of the packet. Thus, both the interrupted transmission and the retransmission are corrupted. Such corruption of a retransmitted packet may be referred to as self-interruption to distinguish this phenomenon from interruption by a second network transmission.

To avoid self-interruption, the wireless device 102 schedules retransmission of the interrupted packet for a time 312 after the original packet transmission would have completed if not interrupted. Thus, embodiments of the wireless device 102 avoid self-interruption and the waste of channel access time caused by multiple retransmissions of the interrupted packet. For fair medium access, the wireless device 102 may add some backoffs (i.e., a randomized delay interval used to reduce the likelihood of collision) to the time for which retransmission is scheduled.

FIG. 4 shows a block diagram of a wireless device 102 including network arbitration and transmission scheduling to improve channel utilization in accordance with various embodiments. The wireless device 102 includes the transceiver 1 104 configured for communication via the first wireless network and the transceiver 2 106 configured for transmission via the second wireless network. The transceivers 104, 106 are coupled to one or more antennas 406. In some embodiments, the transceivers 104, 106 are coupled to one or more different antennas.

The wireless device 102 also includes an arbiter 402 coupled to the transceivers 104, 106. The arbiter 402 determines which of the transceivers 104, 106 is allowed to access the transmission channel (e.g., allowed to transmit) at a given time, and schedules transmissions to optimize utilization of the transmission channel.

The network 1 data source 404 provides data to transceiver 1 104 for transmission on the first network. When data is prepared for transmission, the network 1 data source 404 informs the arbiter 402. The arbiter 402 schedules transmission of the data via transceiver 1 104.

Similarly, the network 2 data source 406 provides data to transceiver 2 106 for transmission on the second network. When data is prepared for transmission, the network 2 data source 406 informs the arbiter 402. The arbiter 402 schedules transmission of the data via transceiver 2 106.

The arbiter 402 schedules transmissions via transceiver 1 104 to reduce wasted channel access time. More specifically, the arbiter 402 schedules transmissions via transceiver 1 104 to avoid interruption by predictable transmissions on the second network, and to avoid multiple retransmissions of a packet caused by a first retransmission that overlaps transmission time allocated to an interrupted transmission of the packet. Similarly, the arbiter 402 can schedule transmissions via transceiver 2 106 to avoid interruption by predictable transmissions on the first network, and to avoid multiple retransmissions as described above. In some embodiments, the arbiter 402 causes the media access control (“MAC”) layer of the wireless device 102 to update a network access control value associated with the first network to delay transmission of a packet for interruption or self-interruption avoidance. In some embodiments, the network access control value determines when an associated transceiver can access a wireless network.

Some embodiments of the wireless device 102 include more than two transceivers. In such embodiments, each transceiver may be configured to operate based on a different wireless technology (e.g., Bluetooth, WLAN, and UMTS). Moreover, when scheduling a transmission via a given transceiver, the arbiter may be configured to consider predictable transmissions via any other transceiver in the wireless device 102.

Various components of the wireless device 102, including at least some portions of the transceivers 104, 106, and the arbiter 402, can be implemented using a processor and software programming that causes the processor to perform the operations described herein. In particular, software programming can be used to cause a processor to provide prediction of transmissions via transceiver 2 106 and scheduling of transmissions via transceiver 1 104. Suitable processors include, for example, general-purpose processors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming can be stored in a computer readable medium. Exemplary computer readable media include semiconductor memory, optical storage, and magnetic storage.

Some embodiments can implement the functionality described herein using dedicated circuitry. Some embodiments may use a combination of dedicated circuitry and software executed on a processor. Selection of a hardware or a software/processor implementation of embodiments is a design choice based on a variety of factors, such as cost and the ability to incorporate changed or additional functionality in the future.

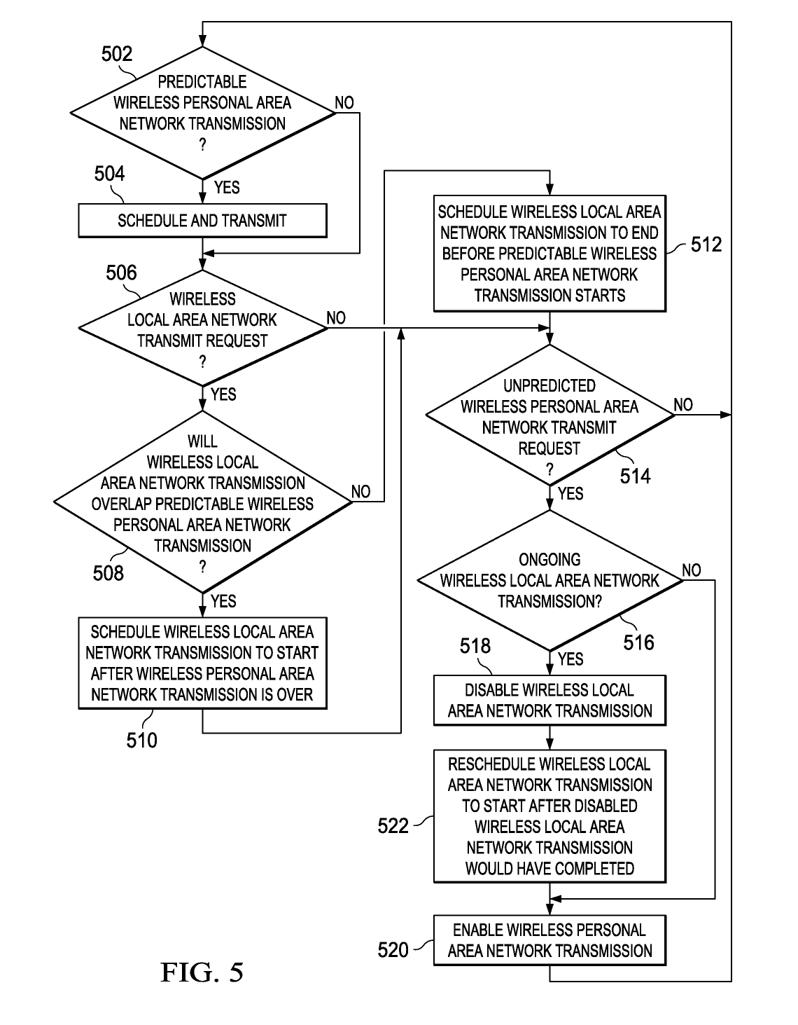

FIG. 5 shows a flow diagram for a method for improving channel utilization by scheduling network transmissions to avoid interruptions and self-interruptions in accordance with various embodiments. Though depicted sequentially as a matter of convenience, at least some of the actions shown can be performed in a different order and/or performed in parallel. Additionally, some embodiments may perform only some of the actions shown. In some embodiments, the operations of FIG. 5, as well as other operations described herein, can be implemented as instructions stored in a computer readable medium and executed by a processor.

In block 502, a wireless device 102 including co-located network transceivers 104, 106 each configured for operation on different and incompatible wireless networks is configured to wirelessly communicate by time multiplexed operation of the transceivers 104, 106. The arbiter 402 determines a start time for a predictable transmission on the second network via transceiver 2 106. The transmission may be predictable, for example, because data, such as audio data, is being transmitted via transceiver 2 106 at a regular interval. If a transmission via transceiver 2 106 is predicted, then some embodiments may reserve a scheduled time for the transmission, and enable transceiver 2 106 to transmit at the scheduled time in block 504.

In block 506, the arbiter 402 receives a request to transmit a packet on the first network via transceiver 1 104. The arbiter 402 determines, in block 508, the time required to transmit the packet, and whether transmission of the packet will overlap any predictable data transmission via transceiver 2 106 if packet transmission is started prior to a predictable data transmission. The time required to transmit the packet may include time for a receiving device to transmit a response or acknowledgement.

If commencing the packet transmission prior to a predictable transmission will cause the packet transmission to overlap the predictable transmission, then, in block 510, the arbiter 402 schedules the packet transmission for a time after the predictable transmission is complete. Otherwise, in block 512, the arbiter 402 schedules the packet to be transmitted starting at a time that allows the packet transmission to complete before the predictable transmission begins.

In block 514, the arbiter receives an unpredicted request to transmit data on the second network via transceiver 2 106. The arbiter 402 determines whether a packet is currently being transmitted on the first network via transceiver 1 104 in block 516. If a packet transmission is ongoing via transceiver 1 104, then, in block 518, the transmission via transceiver 1 104 is disabled. The arbiter 402 schedules the interrupted packet for retransmission in block 522. The retransmission is scheduled to start after the unpredicted transmission is concluded and after the interrupted transmission would have completed had the transmission not been preempted. Some embodiments of the arbiter 402 may add backoffs to randomize the retransmission time. Transceiver 2 106 is enabled to transmit the unpredicted data in block 520.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A wireless device, comprising:
a first wireless transceiver configured for communication via a first wireless network;
a second wireless transceiver configured for communication via a second wireless network; and
an arbiter that controls which of the first and second transceivers is enabled to transmit at a given time;
wherein the arbiter computes a predicted start time for a transmission via the second wireless transceiver and computes a transmission duration for a first packet transmission via the first transceiver, and based on the predicted start time and the computed duration, transmits the first packet at a time when the first packet transmission does not overlap the transmission via the second wireless transceiver.

2. The wireless device of claim 1, wherein communication via the first transceiver conflicts with communication via the second transceiver.

3. The wireless device of claim 1, wherein the arbiter computes a predicted completion time for the transmission via the second wireless transceiver, and schedules the first packet pending transmission for a time after the completion time.

4. The wireless device of claim 3, wherein the wireless device updates a network access control value based on the predicted completion time, and the updated NAV delays the first packet transmission.

5. The wireless device of claim 1, wherein the arbiter computes a transmission duration for a second packet pending transmission via the first transceiver and schedules the second packet for transmission prior to the predicted start time based on the computed duration of the second packet being less than the predicted start time less transmission start time of the second packet.

6. The wireless device of claim 1, wherein the arbiter determines the computed duration based on a time to transmit the first packet and a time for a different wireless device that receives the first packet to transmit a response.

7. The wireless device of claim 1, wherein the first transceiver is configured for operation with one of a wireless local area network and a wireless wide area network, and the second transceiver is configured for use with a wireless personal area network.

8. A wireless device, comprising:
a first wireless transceiver configured for communication via a first wireless network;
a second wireless transceiver configured for communication via a second wireless network; and
an arbiter that controls which of the first and second transceivers is enabled to transmit at a given time;
wherein the arbiter, during a first transmission of a packet via the first transceiver, disables the first transceiver and enables transmission by the second transceiver; and
wherein the arbiter reschedules retransmission of the packet, the rescheduling based on a time after the first transmission of the packet would have completed had the first transceiver not been disabled.

9. The wireless device of claim 8, wherein the arbiter adds backoffs to the time for which the packet retransmission is scheduled.

10. The wireless device of claim 8, wherein the arbiter schedules retransmission of the packet for a time after the transmission by the second transceiver is complete.

11. The wireless device of claim 8, wherein the arbiter bases the time after the first transmission at which retransmission is scheduled on a transmission end time computed based on the length of the packet and a rate at which the packet was transmitted.

12. A method, comprising:
determining a start time for a predictable data transmission via a second wireless transceiver in a wireless device;
receiving a request to transmit a first packet via a first wireless transceiver in the wireless device;
determining whether transmission of the first packet will overlap the predicable data transmission if the first packet transmission is started prior to the predictable data transmission; and
scheduling transmission of the first packet for a time after the predictable data transmission is complete based on determining that the transmission of the first packet will overlap the predictable data transmission.

13. The method of claim 12, further comprising scheduling transmission of the first packet for a time before the predictable data transmission is complete based on determining that the transmission of the first packet will not overlap the predictable data transmission.

14. The method of claim 12, further comprising computing a time required to transmit the packet, the time including a time for a wireless device receiving the packet to transmit a response.

15. The method of claim 12, further comprising updating a network access control value for the first transceiver based on an anticipated completion time of the predictable data transmission.

16. The method of claim 12, wherein communication via the second transceiver interferes with communication via the first transceiver.

17. The method of claim 12, further comprising:
determining that an unpredictable transmission via the second wireless transceiver should preempt an ongoing packet transmission via the first wireless transmitter;
disabling the ongoing packet transmission based on the determining;
enabling the unpredictable transmission based on the determining;
rescheduling the packet transmission for a time after the first transmission would have completed had it not been preempted; and
retransmitting the preempted packet.

18. The method of claim 17, further comprising computing a time at which the preempted packet should be retransmitted, the time including backoffs added to randomize the time.

19. The method of claim 18, wherein the rescheduling includes determining a time for the retransmission based on the transmission time of the unpredictable transmission.

20. The method of claim 19, further comprising computing a transmission end time for the preempted packet based on the length of the packet and a rate at which the packet was transmitted.
